(19) United States
(12) Patent Application Publication
(10) Pub. No.: US 2011/0035783 A1
(43) Pub. Date: Feb. 10, 2011

(54) CONFIDENTIAL INFORMATION LEAK PREVENTION SYSTEM AND CONFIDENTIAL INFORMATION LEAK PREVENTION METHOD

(76) Inventors: Hiroshi Terasaki, Tokyo (JP); Masaru Kawakita, Tokyo (JP); Mitsuteru Tanoue, Tokyo (JP)

Correspondence Address: Mr. Jackson Chen, 6535 N. STATE HWY 161, IRVING, TX, 75039, US

(21) Appl. No.: 12/919,466

(22) PCT Filed: Feb. 4, 2009
(86) PCT No.: PCT/JP2009/051840

§ 371 Date: Oct. 15, 2010

(30) Foreign Application Priority Data
Mar. 3, 2008 (JP) 2008 052713

(51) Int. Cl. G06F 21/00; H04L 9/32

(52) U.S. Cl. 726/1; 726/27

(57) ABSTRACT

There is provided a confidential information leak prevention system in which confidential information and normal information can be simultaneously used without switching an execution environment, and which can prevent information from being leaked. An application behavior controlling unit (103) which is a function of performing behavior control of an application is added to a confidential application (102) activated by using a launcher program (101), and behavior such as printing, copying and pasting, network transmission, communication with a normal application, or a path of file access is controlled. At the same time, an access controlling unit (105) which is a function of controlling file access is introduced, and access from a normal application (104) to a confidential information storing area (116) which is stored by the confidential application (102) is blocked.

### TECHNICAL FIELD

The present invention relates to a confidential information leak prevention system, an information processing device including the same system, a confidential information leak prevention method, and a storage medium that stores a program for causing a computer to execute the same method.

### BACKGROUND ART

Presently, in an organization such as a company, a public office, or a school, an information processing infrastructure called Intranet has been developed for the sake of sharing information.

The Intranet is an aggregation of an arbitrary number of severs and an arbitrary number of clients, both of which are computer systems. There is a case where, in a computer system which includes client computers within a company and a server capable of being connected from these computers, the server within the company manages confidential document files, and the client computers share and use information of these files.

At this time, it is necessary to take measures to prevent leak of confidential information, and thus various confidential information leak prevention systems have been proposed.

Japanese Unexamined Patent Application Publication No. 2005-165900 (Patent Document 1) discloses an example of such a confidential information leak prevention system.

In the confidential information leak prevention system disclosed in the Publication, confidential information is stored as an encrypted file and general information is stored as a plain text file, an execution environment for processing the confidential information and an execution environment for processing the general information are distinguished, the advisability of any access is determined in accordance with the following policies (1) to (4), and an encryption process is performed as needed. (1) Authority to decrypt the encrypted file and authority to write the plain text file are not given to access subjects under the same execution environment. (2) Write authority accompanied by encryption is always given to the access subject to which the authority to decrypt the encrypted file has been given. (3) The authority to decrypt the encrypted file and authority to access a network are not given to access subjects under the same execution environment. (4) Neither encryption authority nor decryption authority of the file is given to an access subject used for copying or moving the file.

### [Patent Document 1]

### Japanese Unexamined Patent Application Publication No. 2005-165900

### DISCLOSURE OF INVENTION

### Technical Problems

Namely, the confidential information leak prevention system disclosed in Patent Document 1 is characterized in that the execution environment for processing the confidential information and the execution environment for processing the general information are switched as needed, so that the information is prevented from being leaked.

However, due to this feature, the confidential information leak prevention system disclosed in Patent Document 1 causes the following two problems.

The first problem is that a user must switch the execution environment in order to prevent the information from being leaked, when the user attempts to use the general information while using the confidential information, or when the user attempts to use the confidential information while using the general information. This requires the user to spend extra time and effort in switching the execution environment, so that the usability for the user is deteriorated.

The second problem is that even when the execution environment for processing the confidential information and the execution environment for processing the general information can be simultaneously executed, it is necessary to use one of the execution environments. When the execution environment for processing the confidential information is used, it is possible to access the confidential information from the execution environment for processing the general information. Alternatively, when the execution environment for processing the general information is used, it is not possible to use the confidential information.

The present invention aims to provide a confidential information leak prevention system, an information processing device including the same system, a confidential information leak prevention method, and a storage medium that stores a program for causing a computer to execute the same method, which can solve the above-mentioned problems.

### Technical Solution

In order to achieve the above-mentioned aim, the present invention provides, as a first exemplary aspect, a confidential information leak prevention system including: an application behavior controlling means for controlling behavior of an object application to be controlled; a process content determining means for determining a content of an access process from an application to a device; a controlled object determining means for determining whether or not the application is the object application to be controlled, in accordance with a result of the determination by the process content determining means; and an access controlling means for disallowing the application to access the device, when the application is not the object application to be controlled as a result of the determination by the controlled object determining means.

Further, the present invention provides, as a second exemplary aspect, an information processing device including: a storage; a central processing unit; a device controlling unit; and an information recorder. The storage stores a launcher program that activates an application that deals with confidential information, a confidential application that deals with the confidential information, a normal application that deals with non-confidential information, a policy that defines an access right to a file, an operating system that manages, operation of the information processing device, and a program that materializes the above-mentioned confidential information leak prevention system. The device controlling unit controls operation of a device connected to the information processing device. The information recorder includes a confidential information storing area that stores the confidential information, and a normal information storing area that stores the non-confidential information.

Further, the present invention provides, as a third exemplary aspect, a confidential information leak prevention method including: a first step of determining a content of an access process from an application to a device; a second step of specifying an application that has accessed the device, in accordance with a result of the determination at the first step, and determining whether or not the application is an object application to be controlled; and a third step of disallowing the application to access the device, when the application is the object application to be controlled as a result of the determination at the second step.

Furthermore, the present invention provides, as a fourth exemplary aspect, a storage medium that stores a program for causing a computer to execute a confidential information leak prevention method. Processes performed by the program include: a first process to determine a content of an access process from an application to a device; a second process to specify an application that has accessed the device, in accordance with a result of the determination at the first process, and to determine whether or not the application is an object application to be controlled; and a third process to disallow the application to access the device, when the application is the object application to be controlled as a result of the determination at the second process.

### ADVANTAGEOUS EFFECTS

The following effects can be achieved by a confidential information leak prevention system, an information processing device including the same system, a confidential information leak prevention method, and a program for causing a computer to execute the same method according to the present invention.

The first effect is that when a confidential application and a normal application are simultaneously used, both applications can be used without switching execution environments of these two applications.

This is because, according to the present invention, operation of an application activated by using a launcher program is controlled as the confidential application, so that it is not necessary to switch the execution environment of the confidential application and the execution environment of the normal application.

The second effect is that it is possible to block access from an execution environment for processing normal information (non-confidential information) to confidential information, when the confidential application and the normal application are simultaneously used.

This is because according to the present invention, a path of a file which is stored by the confidential application is changed, and the normal application is prevented from referring to the confidential information.

### BRIEF DESCRIPTION OF DRAWINGS

FIG. 1 is a block diagram of a confidential information leak prevention system according to a first exemplary embodiment of the present invention;

FIG. 2 is a block diagram of an information processing device which includes therein the confidential information leak prevention system according to the first exemplary embodiment of the present invention;

FIG. 3 is a flowchart showing operation of the information processing device which includes therein the confidential information leak prevention system according to the first exemplary embodiment of the present invention;

FIG. 4 is a table showing determination of allowance or prohibition for file access; and

FIG. 5 is a diagram showing an example of a screen for user authentication.

### EXPLANATION OF REFERENCE

100 INFORMATION PROCESSING DEVICE
101 LAUNCHER PROGRAM
102 CONFIDENTIAL APPLICATION
103 APPLICATION BEHAVIOR CONTROLLING MEANS
104 NORMAL APPLICATION
105 ACCESS CONTROLLING UNIT
106 PROCESS CONTENT DETERMINING MEANS
107 CONTROLLED OBJECT DETERMINING MEANS
108 ACCESS CONTROLLING MEANS
109 OS
110 STORAGE
111 DEVICE CONTROLLING UNIT
112 DISPLAY DEVICE
113 INPUT DEVICE
114 COMMUNICATION DEVICE
115 INFORMATION RECORDER
116 CONFIDENTIAL INFORMATION STORING AREA
117 NORMAL INFORMATION STORING AREA
118 POLICY
119 NETWORK
120 CENTRAL PROCESSING UNIT
121 INFORMATION PROCESSING DEVICE
130 COMMUNICATION LINE
150 CONFIDENTIAL INFORMATION LEAK PREVENTION SYSTEM

### BEST MODES FOR CARRYING OUT THE INVENTION

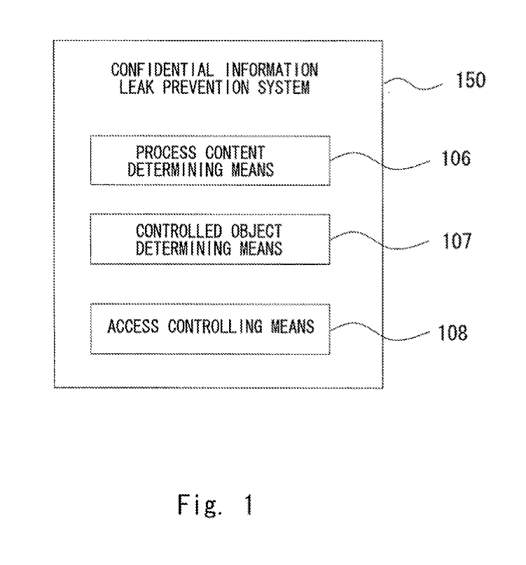

FIG. 1 is a block diagram showing a confidential information leak prevention system 150 according to a first exemplary embodiment of the present invention. The confidential information leak prevention system 150 includes an application behavior controlling means 103 which controls behavior of an object application to be controlled, a process content determining means 106 which determines a content of an access process from an application to a device, a controlled object determining means 107 which determines whether or not the application is the object application to be controlled, in accordance with a result of the determination by the process content determining means 106, and an access controlling means 108 which disallows the application to access the device when the application is not the object application to be controlled as a result of the determination by the controlled object determining means 107.

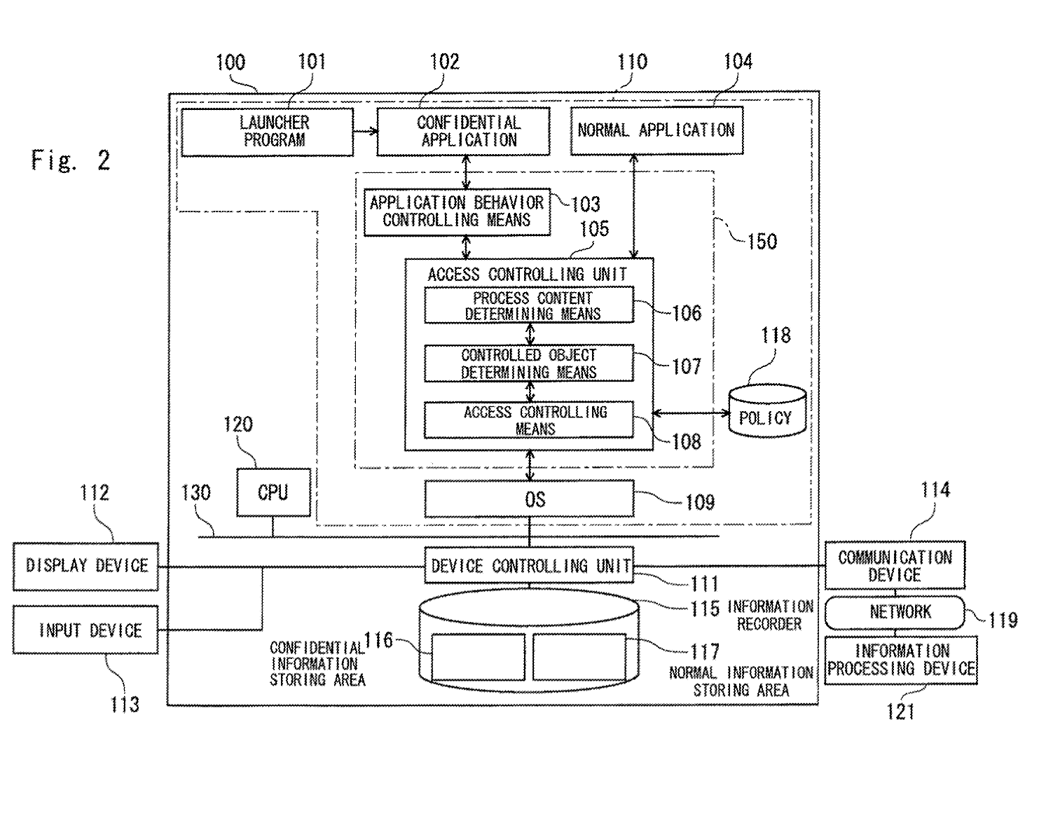

FIG. 2 is a more detailed block diagram of an information processing device 100 which includes therein the confidential information leak prevention system 150 according to the first exemplary embodiment of the present invention.

As shown in FIG. 2, the information processing device 100 includes a storage 110, a CPU (Central Processing Unit) 120, a device controlling unit 111, an information recorder 115, and a communication line 130 which electrically interconnects these elements.

The storage 110 stores a launcher program 101, a confidential application 102, a normal application 104, the confidential information leak prevention system 150 according to the first exemplary embodiment of the present invention, an OS (Operating System) 109, and a policy 118.

Further, the confidential information leak prevention system 150 according to this exemplary embodiment includes the application behavior controlling means 103 which is a function of controlling behavior of the application, and an access controlling unit 105 which is a function of controlling file access. The access controlling unit 105 further includes the process content determining means 106, the controlled object determining means 107, and the access controlling means 108.

The information recorder 115 includes a confidential information storing area 116, and a normal information storing area 117.

The information processing device 100 is connected to each of a display device 112, an input device 113, and a communication device 114. Each of the display device 112, the input device 113, and the communication device 114 is an external device for the information processing device 100.

The launcher program 101 is a program used upon activating an application which deals with confidential information. The application activated by the launcher program 101 becomes the confidential application 102.

While the confidential application 102 is the one which deals with the confidential information, the normal application 104 is the one which deals with normal information.

Further, while the confidential application 102 is activated by the launcher program 101, the normal application 104 is activated as usual, in other words, activated independently of the launcher program 101.

Note that in this specification, the confidential information refers to information which is prohibited from being disclosed to any one other than one having authority. The normal information refers to information other than the confidential information, in other words, information that can be disclosed.

The application behavior controlling means 103 is added to the confidential application 102 which is activated by the launcher program 101.

The application behavior controlling means 103 controls behavior of the confidential application 102 which is the object application to be controlled.

Specifically, the application behavior controlling means 103 hooks calling of a system call for printing, copying and pasting, network transmission, communication with the normal application, or the like which is performed by the application, and blocks the execution of the system call in accordance with the policy 118.

Further, the application behavior controlling means 103 also hooks the calling of the system call upon writing a file, and changes a file path so as to change a writing destination of the file to the confidential information storing area 116. Upon reading the file, the application behavior controlling means 103 reads the file from the confidential information storing area 116. When there is no file in the confidential information storing area 116, the application behavior controlling means 103 reads a file from the normal information storing area 117.

As mentioned above, the access controlling unit 105 includes the process content determining means 106, the controlled object determining means 107, and the access controlling means 108.

The process content determining means 106 determines the content of the access process from the application to the device. Specifically, when the application opens the file or a directory in order to access the information recorder 115, the process content determining means 106 determines whether or not a write flag is added.

The controlled object determining means 107 specifies a application which has accessed the device, in accordance with the result of the determination by the process content determining means 106, and determines whether or not the application is the object application to be controlled, in other words, the confidential application 102. Specifically, the controlled object determining means 107 determines whether or not the access is the one to which a request from the confidential application 102 is added, among requests determined by the process content determining means 106 as the ones to which the write flag is added. In other words, the controlled object determining means 107 determines whether or not the access is the one to which the application behavior controlling means 103 is added.

The access controlling means 108 blocks access to the confidential information storing area 116 from the application determined as not being the confidential application 102, in other words, determined as being the normal application 104 by the controlled object determining means 107.

The OS 109 consists of e.g. Windows® by Microsoft® Corporation.

The communication line 130 consists of e.g. a bus, which electrically interconnects the storage 110, the central processing unit 120, the device controlling unit 111, and the information recorder 115.

The device controlling unit 111 is a control mechanism which controls a hard disk or other types of hardware.

The information recorder 115 consists of the hard disk or other recorders, and includes the confidential information storing area 116 and the normal information storing area 117.

The confidential information storing area 116 records the confidential information which is read and written by the confidential application 102.

The normal information storing area 117 records the normal information which is read and written by the normal application 104. Further, the confidential application 102 performs reading from the normal information storing area 117 only if necessary.

The policy 118 stores a path to be changed upon writing the file as policy information, and stores information to determine permission or prohibition for printing, communication with the normal application, network transmission, or copying and pasting.

The display device 112 consists of e.g. a liquid crystal display or other displays, and the operation thereof is controlled by the device controlling unit 111.

The input device 113 is an input mechanism such as a keyboard or a mouse, and the operation thereof is controlled by the device controlling unit 111.

The communication device 114 is a communication mechanism which performs communication by using LAN (Local Area Network) or the like, and the operation thereof is controlled by the device controlling unit 111. The communication device 114 can communicate with another information processing device 121 through a network 119.

Note that a plurality of shells (not shown) are stored in the storage 110. Each shell is a software module (program) which materializes a user interface provided by the OS ______109 to a user, with respect to copying, moving, renaming or deletion of the file, activation and termination of a program, and the like.

When the plurality of shells are executed, user interfaces which are simultaneously available through the display device 112 and the input device 113 are limited to the ones provided by any one of the shells and a program run from the shell. In other words, the number of shells (programs) which can be seen by the user through the display device 112, i.e. the number of visible shells is always one. Note that a user interface which is provided by a program run from the visible shell is also visible.

When the user uses a user interface provided by another shell (in a case where there is a program run from the shell, the program is included), the user issues a system call for switching the currently visible shell to another shell to the OS 109 through the input device 113.

As shown in FIG. 2, the storage 110 stores the access controlling unit 105 which is composed of the process content determining means 106, the controlled object determining means 107, and the access controlling means 108, and also stores the application behavior controlling means 103. This indicates that the storage 110 stores a program which is executed by the CPU 120 and thereby materializes each of the means 106, 107, 108, and 103 in the information processing device 100.

Further, the program and data stored in the storage 110 can be stored to the information recorder 115 from another device through a storage medium or a communication medium which is available to the information processing device 100. These program and data are output to the storage 110 as needed.

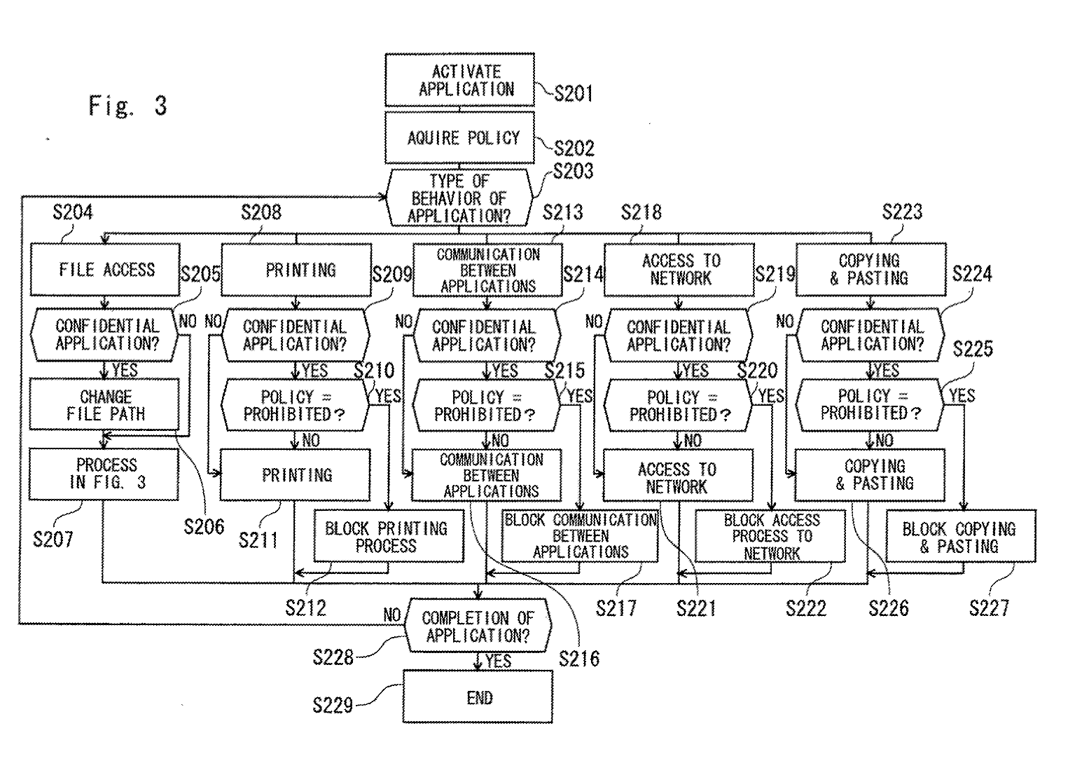

FIG. 3 is a flowchart showing operation of the information processing device 100 which includes therein the confidential information leak prevention system 150 according to the first exemplary embodiment of the present invention.

Hereinafter, the operation of the information processing device 100 which includes therein the confidential information leak prevention system 150 according to the first exemplary embodiment of the present invention will be described with reference to FIG. 3.

The user inputs a boot command through the input device 113, and thereby the CPU 120 boots the information processing device 100.

Then, the user activates the confidential application 102 or the normal application 104 (Step S201). In this case, upon activation of the confidential application 102, the confidential application 102 is activated through the launcher program 101, and the application behavior controlling means 103 serving as the function of controlling behavior of the application is added thereto.

Then, the access controlling means 108 in the access controlling unit 105 accesses the policy 118, and acquires the policy information from the policy 118 (Step S202).

After the acquisition of the policy information, the process content determining means 106 in the access controlling unit 105 determines what operation of the application the user requires (Step S203).

Specifically, the process content determining means 106 in the access controlling unit 105 determines which one of the access to a file, printing, communication with another application, access to the network, and copying and pasting is required by the user as the behavior of the application.

When the process content determining means 106 determines that the behavior of the application required by the user is the access to the file (Step S204), the controlled object determining means 107 determines whether or not the application is the confidential application 102 (Step S205).

For example, the controlled object determining means 107 determines whether or not the application is the confidential application 102, based on whether or not the application has been activated by the launcher program 101, or based on whether or not the application behavior controlling means 103 is added.

When the application is the confidential application 102 (YES at Step S205), the access controlling means 108 transmits a file path changing signal to the application behavior controlling means 103.

The application behavior controlling means 103, which has received the file path changing signal from the access controlling means 108, changes a file path so as to change a writing destination to the file to the confidential information storing area 116, when writing to the file is required (Step S205).

For example, a method disclosed in Japanese Unexamined Patent Application Publication No. 2006-127127 can be used for the change of the file path.

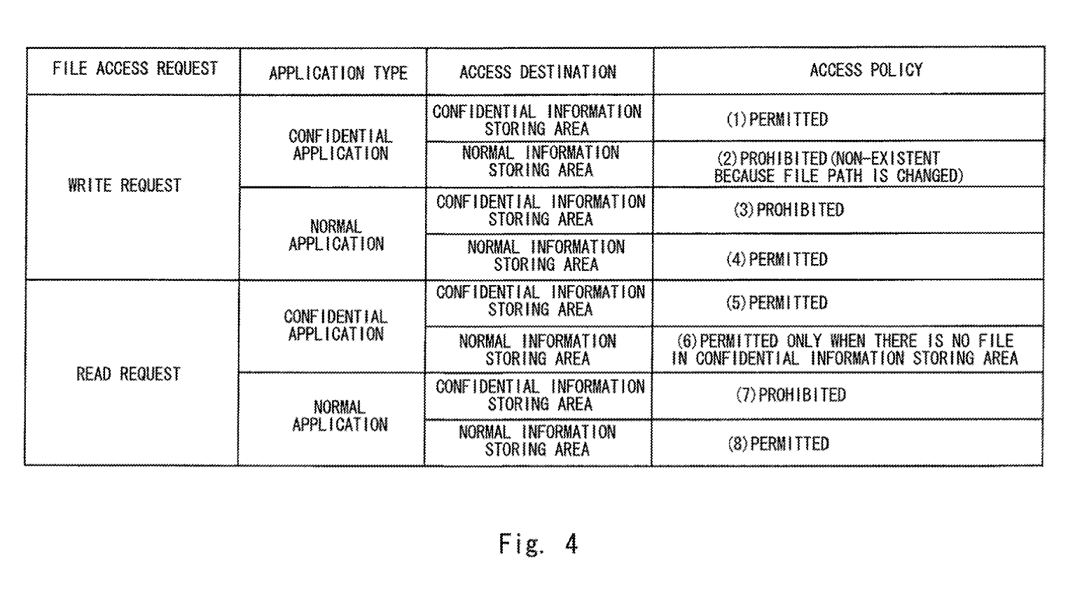

Thereafter, a process for file access is executed in accordance with an access policy shown in FIG. 4 which will be described hereinafter (Step S207).

When the application is not the confidential application 102, in other words, when the application is the normal application 104 (NO at Step S205), the process for file access is executed in accordance with the access policy shown in FIG. 4 (Step S207).

When the process content determining means 106 determines that the behavior of the application required by the user is the printing (Step S208), the controlled object determining means 107 determines whether or not the application is the confidential application 102 (Step S209).

When the application is not the confidential application 102, in other words, when the application is the normal application 104 (NO at Step S209), the printing process is executed (Step S211).

When the application is the confidential application 102 (YES at Step S209), the access controlling means 108 determines whether the printing process is permitted or prohibited in accordance with the policy information already acquired (Step S202) (Step S210).

Note that in the flowchart shown in FIG. 3, the activation of the application (Step S201) is followed by the acquisition of the policy (Step S202). However, the acquisition of the policy can be performed at an arbitrary step before the determination as to whether the printing process is permitted or prohibited (Step S210).

When the printing process is prohibited (YES at Step S210), the access controlling means 108 blocks the printing process (Step S212).

When the printing process is not prohibited (NO at Step S210), the printing process is executed (Step S211).

When the process content determining means 106 determines that the behavior of the application required by the user is the communication with another application (Step S213), the controlled object determining means 107 determines whether or not the application is the confidential application 102 (Step S214).

When the application is not the confidential application 102, in other words, when the application is the normal application 104 (NO at Step S214), a communication process with another application is executed (Step S216).

When the application is the confidential application 102 (YES at Step S214), the access controlling means 108 determines whether the communication process with another application is permitted or prohibited in accordance with the already acquired policy information (Step S202) (Step S215).

When the communication process with another application is prohibited (YES at Step S215), the access controlling means 108 blocks the communication process with another application (Step S217).

When the communication process with another application is not prohibited (NO at Step S215), the communication process with another application is executed (Step S216).

When the process content determining means 106 determines that the behavior of the application required by the user is the access to the network (Step S218), the controlled object determining means 107 determines whether or not the application is the confidential application 102 (Step S219).

When the application is not the confidential application 102, in other words, when the application is the normal application 104 (NO at Step S219), the access to the network is executed (Step S221).

When the application is the confidential application 102 (YES at Step S219), the access controlling means 108 determines whether the access to the network is permitted or prohibited in accordance with the already acquired policy information (Step S202) (Step S220).

When the access to the network is prohibited (YES at Step S220), the access controlling means 108 blocks the access to the network (Step S222).

When the access to the network is not prohibited (NO at Step S220), the access to the network is executed (Step S221).

When the process content determining means 106 determines that the behavior of the application required by the user is the copying and pasting (Step S223), the controlled object determining means 107 determines whether or not the application is the confidential application 102 (Step S224).

When the application is not the confidential application 102, in other words, when the application is the normal application 104 (NO at Step S224), the copying and pasting is executed (Step S226).

When the application is the confidential application 102 (YES at Step S224), the access controlling means 108 determines whether the copying and pasting is permitted or prohibited in accordance with the already acquired policy information (Step S202) (Step S225).

When the copying and pasting is prohibited (YES at Step S225), the access controlling means 108 blocks the copying and pasting (Step S227).

When the copying and pasting is not prohibited (NO at Step S225), the copying and pasting is executed (Step S226).

Then, the process content determining means 106 in the access controlling unit 105 determines whether or not the entire behavior of the application required by the user has been completed (Step S228).

When the entire behavior of the application required by the user has not been completed (NO at Step S228), the process content determining means 106 in the access controlling unit 105 determines what behavior of the application the user requires (Step S203), and thereafter it is determined whether or not to permit the behavior.

When the entire behavior of the application required by the user has been completed (YES at Step S228), the process ends (Step S229).

FIG. 4 is a table showing the determination of permission or prohibition for the file access, which is performed at Step S207 by the access controlling means 108 in the access controlling unit 105.

When the behavior of the application required by the user is the access to the file (Step S204), the process content determining means 106 in the access controlling unit 105 determines whether the request for the file access is a request to write to the file or a request to read from the file, and determines whether the requested object is the confidential information storing area 116 or the normal information storing area 117.

Further, the controlled object determining means 107 in the access controlling unit 105 determines whether the application designated by the user is the confidential application 102 or the normal application 104.

Contents of the determination by the access controlling means 108 vary depending on (1) whether the request from the user is the request to write to the file or the request to read from the file; (2) whether the required object is the confidential information storing area 116 or the normal information storing area 117; and further (3) whether the application designated by the user is the confidential application 102 or the normal application 104.

When the request from the user is the request to write to the file, the required object is the confidential information storing area 116, and the application designated by the user is the confidential application 102, the access controlling means 108 in the access controlling unit 105 permits a request to write to the confidential information storing area 116 by the confidential application 102, as indicated in an access policy (1).

When the request from the user is the request to write to the file, the required object is the normal information storing area 117, and the application designated by the user is the confidential application 102, the access controlling means 108 in the access controlling unit 105 prohibits a request to write to the normal information storing area 117 by the confidential application 102, as indicated in an access policy (2). However, in this case, the file path is changed by the application behavior controlling means 103, so that the request itself cannot exist.

When the request from the user is the request to write to the file, the required object is the confidential information storing area 116, and the application designated by the user is the normal application 104, the access controlling means 108 in the access controlling unit 105 prohibits a request to write to the normal information storing area 117 by the normal application 104, as indicated in an access policy (3).

When the request from the user is the request to write to the file, the required object is the normal information storing area 117, and the application designated by the user is the normal application 104, the access controlling means 108 in the access controlling unit 105 permits a request to write to the normal information storing area 117 by the normal application 104, as indicated in an access policy (4).

When the request from the user is the request to read from the file, the required object is the confidential information storing area 116, and the application designated by the user is the confidential application 102, the access controlling means 108 in the access controlling unit 105 permits a request to read from the confidential information storing area 116 by the confidential application 102, as indicated in an access policy (5).

When the request from the user is the request to read from the file, the required object is the normal information storing area 117, and the application designated by the user is the confidential application 102, the access controlling means 108 in the access controlling unit 105 permits the request only if the access controlling unit 105 confirms that there is no file in the confidential information storing area 116 as indicated in an access policy (6), and prohibits the request if the access controlling unit 105 confirms that there is a file in the confidential information storing area 116.

When the request from the user is the request to read from the file, the required object is the confidential information storing area 116, and the application designated by the user is the normal application 104, the access controlling means 108 in the access controlling unit 105 prohibits a request to read from the confidential information storing area 116 by the normal application 104, as indicated in the access policy (5).

When the request from the user is the request to read from the file, the required object is the normal information storing area 117, and the application designated by the user is the normal application 104, the access controlling means 108 in the access controlling unit 105 permits a request to read from the normal information storing area 117 by the normal application 104, as indicated in the access policy (5).

Next, effects which can be achieved by the confidential information leak prevention system 150 according to this exemplary embodiment will be described.

In the confidential information leak prevention system 150 according to this exemplary embodiment, the behavior of the confidential application 102 activated by using the launcher program 101 is controlled, so that the confidential information is prevented from being leaked. Further, the path of the file which is stored by the confidential application 102 is changed, and the access to the changed file path from the normal application 104 is blocked, so that the normal application is prevented from leaking the confidential information.

Therefore, it is possible to simultaneously materialize an execution environment for processing the confidential information and an execution environment for processing the normal information, and to prevent the confidential information from being leaked.

The confidential information leak prevention system 150 according to this exemplary embodiment is not limited to the above-mentioned configuration, and can be variously modified as follows. Hereinafter, modified examples of the confidential information leak prevention system 150 according to this exemplary embodiment will be described.

### First Modified Example

In the information processing device 100 which includes the confidential information leak prevention system 150 according to this exemplary embodiment, the launcher program 101 is executed to thereby activate the confidential application 102. Upon execution of the launcher program 101, it is possible to display an authentication screen on the display device 112, and to perform user authentication of the user.

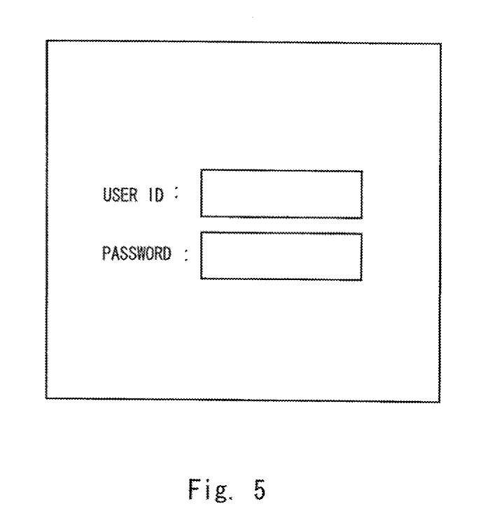

FIG. 5 shows an example of the screen for the user authentication.

When the launcher program 101 is activated, the authentication screen as shown in FIG. 5 is displayed on a display screen of the display device 112.

The user of the information processing device 100 inputs a user's own user ID and password to the authentication screen through the input device 113.

The CPU 120 compares the inputted user ID and password with a user ID and a password which are preliminarily designated by the user and stored, and permits the subsequent execution of the launcher program 101 only when both the user IDs and passwords coincide with each other. In other words, only when the authentic user ID and password are inputted, the confidential application 102 is activated through the launcher program 101.

### Second Modified Example

In the information processing device 100 which includes the confidential information leak prevention system 150 according to this exemplary embodiment, the application behavior controlling means 103 changes the path of the file which is stored by the confidential application 102 so as to change the writing destination of the file to the confidential information storing area 116 upon writing the file.

Upon changing the file path, the application behavior controlling means 103 can encrypt the changed file path. In the case where the changed file path has been encrypted, the application behavior controlling means 103 decrypts the file path upon reading the file.

### Third Modified Example

In the second modified example, the access controlling unit 105 can also perform the encryption and decryption of the file path, instead of the application behavior controlling means 103.

### Fourth Modified Example

In the information processing device 100 which includes the confidential information leak prevention system 150 according to this exemplary embodiment, the display device 112, the input device 113, and the communication device 114 are arranged as the external devices for the information processing device 100. Meanwhile, the information processing device 100 can include the display device 112, the input device 113, and the communication device 114 as constituent elements.

### MODE FOR THE INVENTION

Hereinafter, specific operation of the information processing device 100 which includes the confidential information leak prevention system 150 according to this exemplary embodiment will be described.

Firstly, when an application which operates on the Windows® as the OS 109 is activated, a list of confidential files is displayed. The list includes various files such as a document file and a spreadsheet file.

When one of the confidential files is double-clicked, the application is activated through the launcher program 101.

The activated application displays a content of the confidential file, thereby enabling use of printing, network transmission, copying and pasting, or other various actions from a menu.

For example, when the printing is selected from the menu and the printing is prohibited by the policy 118 (Step S208), a message indicating prohibition of the printing is displayed on a display screen and the printing is prohibited.

Further, the network transmission, the copying and pasting, or the like is the same as in the printing. When the network transmission or the copying and pasting is prohibited by the policy 118 (Step S216 or S220), a message indicating prohibition of the network transmission, or the copying and pasting is displayed on the display screen, and the network transmission or the copying and pasting is prohibited.

Note that regarding the timing of performing the copying and pasting, an application for a document, a spreadsheet, or the like (application other than the confidential application 102) may be preliminarily activated by a normal activation method not through the launcher program 101, or may also be activated after the activation of the confidential application 102.

When the confidential application 102 edits and then stores the content, the application behavior controlling means 103 changes a file path to the one to be changed upon writing the file, so that the content is forcibly stored in the confidential information storing area 116.

For example, even in the case of attempting to store the edited confidential application 102 in “C:\confidential_document.txt”, it is forcibly stored in “C:\secret\confidential_document.txt”.

When a list of files in “C:\” is displayed in the case of attempting to open the stored file through the confidential application 102, the application behavior controlling means 103 presents to the user that the file stored in “C:\secret\confidential_document.txt” seems to exist in “C:\confidential_document.txt”. When the user attempts to open the stored file, file access is permitted by the process content determining means 106, the controlled object determining means 107, and the access controlling means 108, and thus the user can naturally refer to the stored file.

Further, even in the case of attempting to display a list of files in “C:\secret” through the normal application 104, the existence of the file stored in “C:\secret\confidential_document.txt” which exists as an entity is concealed by the process content determining means 106, the controlled object determining means 107, and the access controlling means 108. Therefore, the normal application 104 cannot refer to “confidential_document.txt”.

While the confidential information leak prevention system is covered as an exemplary embodiment of the present invention, the same effects as the confidential information leak prevention system according to the present invention can be achieved by an information processing device which includes the same system, a confidential information leak prevention method, and a program for causing a computer to execute the same method.

Namely, when the confidential application (application using the confidential information) is activated by using the launcher program, the function of performing the behavior control of the application is added to the confidential application activated by using the launcher program, and the behavior of the application (printing, copying and pasting, network transmission, communication with the normal application, path of file access, or the like) is controlled.

At the same time, the function of controlling the access is introduced, the process content is analyzed and whether or not the application is activated by using the launcher program is judged, and the access from the normal application 104 to the file stored by the confidential application 102 is blocked.

As described above, even when the confidential application 102 and the normal application 104 are simultaneously used, simultaneous use of both applications can be materialized without switching the execution environment. Therefore, it is possible to ensure the convenience for the user.

Note that the above-mentioned program can be stored in various types of storage media, and can be transmitted through communication media. Examples of the storage media include a flexible disk, a hard disk, a magnetic disk, a magnet-optical disk, a CD-ROM, a DVD, a ROM cartridge, a RAM memory cartridge with battery backup, a flash memory cartridge, and a nonvolatile RAM cartridge. Further, the communication media include a wired communication medium such as a telephone line, a wireless communication medium such as a microwave line, and the Internet.

Hereinbefore, while the present invention has been described with reference to the exemplary embodiments thereof, the present invention is not limited to the above description. It will be understood by those of ordinary skill in the art that various changes in form and details may be made therein within the scope of the present invention.

This application is based upon and claims the benefit of priority from Japanese patent application No. 2008-052713, filed on Mar. 3, 2008, the disclosure of which is incorporated herein in its entirety by reference.

### INDUSTRIAL APPLICABILITY

The present invention is applicable to a confidential information leak prevention system, an information processing device including the same system, a confidential information leak prevention method, and a program for causing a computer to execute the same method.

1-21. (canceled)

22. A confidential information leak prevention system comprising:
an application behavior controlling unit that controls behavior of an object application to be controlled;
a process content determining unit that determines a content of an access process from an application to a device;
a controlled object determining unit that determines whether or not the application is the object application to be controlled, in accordance with a result of the determination by the process content determining unit and whether or not the application is activated by a launcher program; and
an access controlling unit that disallows the application to access the device, when the application is not the object application to be controlled as a result of the determination by the controlled object determining unit.

23. The confidential information leak prevention system according to claim 22, wherein
the launcher program adds the application behavior controlling unit to the application activated by the launcher program, and
the application behavior controlling unit excludes the application activated by the launcher program from a controlled object for access to a confidential information storing area.

24. The confidential information leak prevention system according to claim 22, wherein the application activated by the launcher program and an application that is not the object to be controlled can be simultaneously used.

25. The confidential information leak prevention system according to claim 22, wherein the application behavior controlling unit hooks calling of a system call with respect to behavior of the application for printing, copying and pasting, network transmission, or communication with a normal application, and blocks execution of the system call in accordance with a policy, or hooks calling of a system call with respect to behavior of the application for file access and changes a file path of the file access.

26. The confidential information leak prevention system according to claim 23, wherein the controlled object determining unit determines whether or not the application is the object application to be controlled, based on whether or not the application behavior controlling unit is added.

27. The confidential information leak prevention system according to claim 25, wherein the application behavior controlling unit changes, upon writing a file, the file path so as to change a writing destination of the file to a confidential information storing area, reads the file from the confidential information storing area upon reading the file, and reads a file from a normal information storing area when there is no file in the confidential information storing area.

28. The confidential information leak prevention system according to claim 22, wherein the access controlling unit determines whether or not to allow the application to access the device in accordance with a predetermined policy, when the application is the object application to be controlled as the result of the determination by the controlled object determining unit.

29. An information processing device comprising:
a storage;
a central processing unit;
a device controlling unit; and
an information recorder,
wherein the storage stores a launcher program that activates an application that deals with confidential information, a confidential application that deals with the confidential information, a normal application that deals with non-confidential information, a policy that defines an access right to a file, an operating system that manages operation of the information processing device, and a program that materializes the confidential information leak prevention system according to claim 22,
the device controlling unit controls operation of a device connected to the information processing device, and
the information recorder includes a confidential information storing area that stores the confidential information, and a normal information storing area that stores the non-confidential information.

30. A confidential information leak prevention method comprising:
determining a content of an access process from an application to a device;
specifying an application that has accessed the device, in accordance with a result of the determination, and determining whether or not the application is an object application to be controlled based on whether or not the application is activated by a launcher program; and
disallowing the application to access the device, when the application is not the object application to be controlled as a result of the determination as to whether or not the application is the object application to be controlled.

31. The confidential information leak prevention method according to claim 30, further comprising excluding the application activated by the launcher program from a controlled object for access to a confidential information storing area.

32. The confidential information leak prevention method according to claim 30, further comprising:
hooking calling of a system call with respect to behavior of the object application to be controlled for printing, copying and pasting, network transmission, or communication with a normal application; and
blocking execution of the system call in accordance with a policy.

33. The confidential information leak prevention method according to claim 30, further comprising:
hooking calling of a system call with respect to behavior of the object application to be controlled for file access; and
changing a file path of the file access.

34. The confidential information leak prevention method according to claim 33, further comprising:
changing, when a file is written by the object application to be controlled, the file path so as to change a writing destination of the file to a confidential information storing area;
reading the file from the confidential information storing area when the file is read by the object application to be controlled; and
reading a file from a normal information storing area when there is no file in the confidential information storing area.
